(19) United States
(12) Patent Application Publication
(10) Pub. No.: US 2008/0203751 A1
(43) Pub. Date: Aug. 28, 2008

(54) Hybrid Under-Body Lining

(76) Inventor: Alexander Wildhaber, Walenstadt (CH)

Correspondence Address: STURM & FIX LLP, 206 SIXTH AVENUE, SUITE 1213, DES MOINES, IA, 50309-4076, US

(21) Appl. No.: 11/916,217

(22) PCT Filed: Jun. 7, 2006
(86) PCT No.: PCT/CH2006/000307

§ 371 Date: Nov. 30, 2007

(30) Foreign Application Priority Data
Jun. 7, 2005 (DE) 20 2005 008 921.4

(51) Int. Cl. B60R 13/08

(52) U.S. Cl. 296/39.3

(57) ABSTRACT

The invention relates to an acoustically effective underfloor cladding A), for a vehicle comprising at least one form-stabilising structure (b) in which at least one acoustically-effective material (a, a_{2 . . . x}) is embedded. The distribution, thickness and type of the material embedded in the acoustically-effective region is selected such that the locally different acoustic conditions are optimally accounted for.

This invention relates to an under-body lining for vehicles in accordance with the characterising clause for claim 1.

Under-body linings for vehicles are basically known and are used to protect the vehicle components fitted to the body, or to improve the aerodynamic performance of the vehicle. As a rule, these under-body linings are produced from long fiber reinforced thermoplastics and dimensioned so that they can be installed as structural components, i.e., with a high degree of intrinsic-rigidity and stability of form. It is obvious that linings of this kind have no acoustic effectiveness.

Accordingly, it has been suggested in the past that these rigid under-body linings should be provided with an acoustically effective, i.e., noise damping, noise absorbing and noise insulating layer. Unfortunately, this results in an undesirable increase in the weight of the entire lining component and also requires additional securing points. This in turn leads to an undesirable increase in assembly costs and operating costs for the vehicle. For this reason, wheel arch shells in which individual areas made of a nonwoven textile material are enclosed within a rigid plastic framework have also become known. These wheel arch shells are light and extremely effective in acoustic terms. However, their elastic properties and the low level of resistance (high susceptibility to abrasion) of the nonwoven textile materials producing the acoustic effect rapidly lead to undesirable instances of wear.

Accordingly, the purpose of this invention is to create a low weight under-body lining for vehicles that do not have the disadvantages of the known lining components, and, in particular, allowing at the same time for good mechanical properties and enhanced acoustic effectiveness in the long term. In particular, the intention is to create an under-body lining that is optimally adapted to the local areas that are sources of noise, such as the exhaust system area, the area offering protection against stones or areas of increased acoustic pressure level, i.e., displaying varying local acoustic properties.

This task is solved in accordance with the invention by means of an under-body lining with the characteristics of claim 1, and, in particular, with an acoustically effective under-body lining for a vehicle, wherein this under-body lining displays at least one form stabilizing area and at least one acoustically effective area, whereby the acoustically effective area includes an open-port or carpet like material and the form stabilising area includes a thermoplastic, elastomer or duroplastic material, and whereby the material of the acoustically effective area is at least partially embedded in the material of the form stabilising area, or is integrated within it. Here, the acoustically effective area preferably covers a portion of the area of between 5% and 95%, preferably between 20% and 60% of the entire lining component. In accordance with the invention, the distribution, thickness and/or type of the material embedded in the acoustically effective area is variable, with the aim of achieving acoustic effects adapted in accordance with the different local areas that are sources of noise or areas of vibration. Here, the thickness of the acoustically effective material can be greater than the thickness of the form stabilising material. This means that the acoustically effective material can also serve as a spacer or as a securing element offering an increased level of acoustic and mechanical effectiveness at the same time. The hybrid construction of the under-body lining in accordance with the invention makes it possible to simply produce an arrangement in the acoustically effective areas that is optimally adapted to the local conditions and is effective. In particular, the widest variety of materials or material mixtures can be used in order to create an optimum acoustic and form stabilising effect.

The form-stabilising areas have a single or multiple-ply material structure and are preferably constructed of plastic-plastic, fibre-fibre or plastic-fibre mixtures (also with BiCo fibres), preferably in the form of grids or sheets. It is obvious that these areas arranged in skeleton fashion can also be built up with a number of layers or can be produced from metallic material, in particular, aluminum. In a preferred embodiment, this area consists of a consolidated, i.e., compacted single-ply plastic which can be non-reinforced, fibre reinforced using other fillers.

For the acoustically effective areas, all types of acoustically effective material can be used, in particular foams, fibre materials, compressed fibre mixtures, non-compressed fibre mixtures as well as all combinations featuring plastic grids or multiple-ply laminates of these materials. It is obvious that the acoustically effective materials can also be designed as chamber or sheet absorber, micro-perforated sheets in plastic or aluminum.

In addition, the acoustically effective materials embedded in the form stabilising material can also be embedded in this form stabilising material using an intermediate bonding material. As a basic principle, the acoustically effective materials can be embedded by means of material bonding, form fitting or an adhesive process.

In a further development of this invention, the intermediate space created when the under-body lining is fitted can be provided at least partially with an acoustically effective intermediate layer. This intermediate layer can take the form of a single and/or multiple porous and/or non-porous absorber layer, a multi-ply sheet absorber or a chamber absorber, or may display any other acoustically effective construction. In a special embodiment, at least the area stabilising the form feature holes or perforations serving to drain off water or equalize pressure. At the same time, apertures of this kind serve to couple the external acoustic field to the intermediate layer. It is obvious that the intermediate layer can also include heat screening layers with or without perforations and can create additional layers of air.

Without the need for any further inventive step, the person skilled in the art will be able to use the construction of this under body lining in accordance with the invention for components inside the vehicle, in particular for engine compartment linings, partition modules, parcel shelves, roof lining modules, or boot linings.

The following section provides further explanation of the invention with reference to a sample Here:

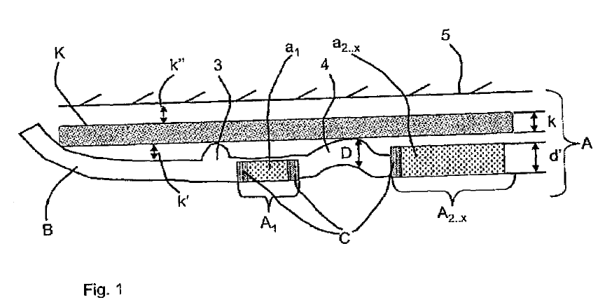

FIG. 1 shows a schematic view of a section of an under-body lining in accordance with the invention in installed condition;

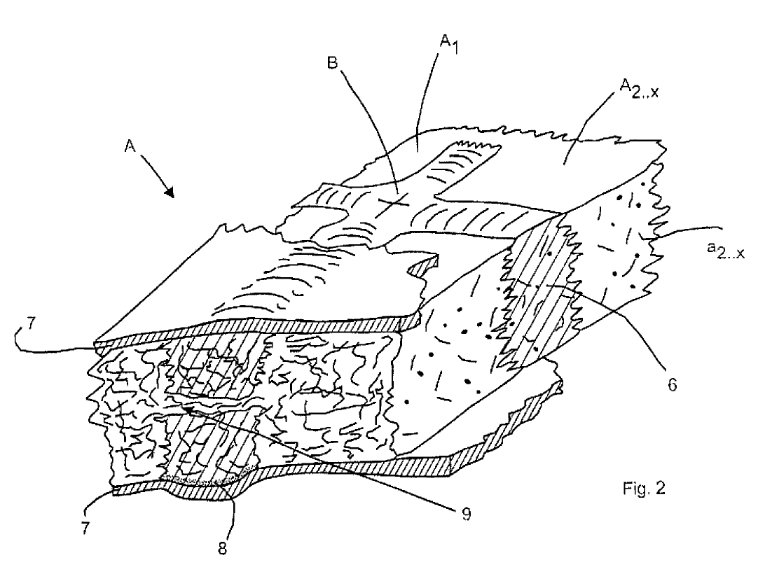

FIG. 2 shows a spatial view through a cut under-body lining in accordance with the invention.

FIG. 1 shows the under-body lining A in accordance with the invention in installed condition. This under-body lining includes a form stabilizing structure B with acoustically effective materials a₁ and a_{2 . . . x} embedded therein. The form stabilising structure B may display additional local stabilising variations in shapes 3,4. This structure B is preferably made of a thermoplastic polymer, in particular polypropylene or polyamide. It is obvious that this material can be reinforced with fibres or other fillers. In another embodiment, the form stabilising structure B is made of an elastomer, in particular an EPDM. In a further embodiment, this form stabilising structure B is made of a duroplastic material, in particular an unsaturated polyester or polyurethane.

In this sample embodiment, the acoustically effective material a₁ is embedded in a recess provided for the purpose with a proportional area A₁. As an additional feature, it is also possible to integrate bonding transitional materials c into the same recess in order to secure the acoustically effective material therein. In another embodiment, the form stabilizing structure B has an open area A_{2 . . . x} in which an acoustically effective material a_{2 . . . x} is integrated. In this embodiment the acoustically effective material a_{2 . . . x} can have a greater thickness d′, than the form stabilising structure. This acoustically effective material a₁ and a_{2 . . . x} can be made of a foam, fibre materials, compressed fiber mixtures with or without plastic grids or multi-ply laminates. Here, the acoustically effective A₁ and A_{2 . . . x} preferably covers a proportion of the area of between 5% and 95%, preferably between 20% and 60% of the entire lining area A.

The material used is made preferably from multi-ply and/or single-ply theremoplastics, particularly in the form of nonwoven materials, sheets, grids, woven textiles, fibre layers or combinations of these. Bi-components fibers (BiCo fibers) with a fibre weight of 1.0-100 dtex are advantageous. It is obvious that the materials used are made of mixtures of bi-component fibres with differing fiber weights, in particular weights of 1-10, 11-20 and 21-30 dtex.

In a further embodiment, there is an intermediate layer K inserted between the form stabilising structure B and a vehicle under-body 5. This intermediate layer K can fill the entire intermediate space between the under-body lining A and the vehicle under body 5, or can be of a thickness k so that there are additional layers of air with a thickness of k′ or k″ created in this intermediate space. It is obvious that the intermediate layer K can also include heat screening layers with or without perforations.

In a further embodiment, the form stabilising structure comprises additional perforations serving to drain off water and allowing for pressure equalization. At the same time, these perforations permit acoustic coupling of the external acoustic field to the intermediate layer K.

FIG. 2 shows a spatial illustration of a cut under-body lining in accordance with the invention. In accordance with the invention, this under-body lining A has a form stabilising structure B and at least one acoustically effective area A₁ and A_{2 . . . x}. For this purpose, there are acoustically effective materials a₁ and a_{2 . . . x} embedded in this form stabilising structure B. Here, the form stabilising structure presents a grid type shape, with the intervals between the individual grid bars 6, i.e., the grid width, preferably lying within the range of 0.5 to 500 mm. With this preferred embodiment, the width of the individual grid bars 6 lies within the range of 0.5 to 20 mm. The height of these bars 6 varies within the range of 0.1 to 10 mm. Materials that are particularly suitable for the creation of this form stabilizing grid are thermoplastics, duroplastics, polyester-co-polymers, glass compound materials, glass layered textile materials impregnated with plastic etc.

It is obvious that additional form stabilising layers 7 in the form of textile materials, layers of nonwoven materials, sheets, or meshes can be provided at the top and or underside. These additional form stabilising layers 7 at the top and/or underside preferably include thermoplastics, such as PP, PE, PA, PET and/or organic or inorganic duroplastics, fibre glass or mixtures and combinations of these materials. The arrangement of the additional layers 7 can be unidirectional or offset against the direction of the bars 6, with the connection of these layers 7 taking place at the crossover points or at the areas of overlap with the bars 6. These layers 7 may be heat welded on to the material of the bars 6, as they can to the material a₁ and a_{2 . . . x} of the acoustically effective areas A₁ and A_{2 . . . x}. As a result of the heat welding of these additional layers 7, a process of local impregnation takes place accompanied by local stiffening of the acoustically effective material.

In a further embodiment of this invention, the additional layers 7 include a single nonwoven material or a multi-ply nonwoven material made of organic and/or inorganic materials. With these nonwoven materials, it is possible to set the degree of resistance to air flow in a simple manner. The value for the air flow resistance is preferably set within the range of 50-5,000 Ns/m³. The thickness of these layers of non-woven material is preferably within the range of 0.05-20 mm. The grammage (area weight) of these layers is preferably 0.5-3,000 g/m².

It is obvious that these additional layers can also include a single sheet or multi-ply sheet. Sheets of this kind can include plastic materials of the thermoplastic or duroplastic type, metallic sheets and/or combinations of these materials. The grammage of sheet layers of this kind lies preferably within the range of 0.05-500 g/m², while the thickness of these lies within the range of 0.02-10 mm. The use of micro-perforated sheets will also be evident to the person skilled in the art, those sheets preferably producing an air flow resistance within the range of 50-5,000 Ns/m³.

These additional layers 7 are secured in a preferred embodiment by means of a material bonding connection 8, to the bars 6. In a further embodiment of the under-body lining A in accordance with the invention, the form stabilising bars 6 do not run through the entire structure, but are broken in the core area, i.e., broken in the middle, so that within such a break 9 there can be open pore or carpet type material (a₁ a_{2 . . . x}) arranged to permit movement and in this way vibration movements in the bars 6 can be dissipated via this fiber material.

Additional embodiments of the under-body lining in accordance with the invention lie within the normal technical abilities of the person skilled in the art. Accordingly, for the form stabilising structure B and for the acoustically effective areas A₁ and A_{2 . . . x} use can be made of the same basic material, for example polypropylene in the form of consolidated plastic material or in the form of open pore mixed fiber material. It is obvious that the acoustically effective materials are attached to the form stabilising structure B by welding or bonding, stapling, clamping, hooking on or by means of the injection molding method. Similarly, the acoustically effective material can be embedded into the form stabilizing structure to varying depths, so that the depth of embedding shows a partially lower degree of consolidation. In particular, the fibres in the core (middle) of the form stabilising area can be embedded in partially reduced fashion, so that the fibres remain movable. Preferably, all areas or at least some parts of the nonwoven materials and/or sheets are materially bonded to the form stabilising areas and the acoustically effective areas.

1. Acoustically effective under-body lining for a vehicle, which under-body lining comprises at least one form stabilising area and at least one acoustically effective area the acoustically effective area comprises an open pore or carpet like material and the form stabilising area comprises a thermoplastic, elastomer or duroplastic material, with the material of the acoustically effective area being embedded in the material of the form stabilising area to at least a degree of partial penetration.

2. Under-body lining in accordance with claim 1 wherein the open port or carpet type material has an air flow resistance of R of 50 Nsm⁻³<R<5,000 Nsm⁻³.

3. Under-body lining in accordance with claim 1, wherein the form stabilising area is perforated.

4. Under-body lining in accordance with claim 1 wherein it comprises a number of acoustically effective areas in which various materials and/or material of varying thickness are embedded.

5. Under-body lining in accordance with claim 1 wherein the acoustically effective area represents a proportion of the area of between 5% and 95%, preferably 20%-60%, of the entire area of the under-body lining.

6. Under-body lining in accordance with claim 4, wherein the distribution, thickness and type of the material embedded in the acoustically effective area is selected so that a varying acoustic effect can be created to be optimally adapted to the local areas representing sources of noise.

7. Under-body lining in accordance with claim 1, wherein it has at least one additional layer 7 on the underside and/or top side.

8. Under-body lining in accordance with claim 7, wherein this additional layer 7 is a layer of the grid, nonwoven material or sheet type.

9. Under-body lining in accordance with claim 7, wherein this layer has an air flow resistance of R of 50 Nsm⁻³<R<5,000 Nsm⁻³.
